(19) United States
(12) Patent Application Publication
(10) Pub. No.: US 2010/0213701 A1
(43) Pub. Date: Aug. 26, 2010

(54) METHOD AND DEVICE FOR JOINING PIPES

(75) Inventors: Gunnar Blomqvist, Helsingby (FI); Jan Skoglund, Helsingby (FI)

Correspondence Address: CONNOLLY BOVE LODGE & HUTZ LLP, 1875 EYE STREET, N.W., SUITE 1100, WASHINGTON, DC, 20006, US

(73) Assignee: Oy KWH Pipe Ab, Vasa (FI)

(21) Appl. No.: 11/994,909

(22) PCT Filed: Jul. 7, 2006
(86) PCT No.: PCT/FI2006/050325

§ 371 Date: Sep. 8, 2009

(30) Foreign Application Priority Data
Jul. 8, 2005 (FI) 20050735

(51) Int. Cl. F16L 47/03; F16L 47/00

(52) U.S. Cl. 285/21.2; 285/382.7

(57) ABSTRACT

The invention concerns a method and device for joining thermoplastics pipes manufactured by spiral winding of a hollow profile. The method according to the invention is characterized in that a welding mirror (5) adaptable to the prepared end surfaces of the pipes and provided with heating means, is inserted in the slot between the pipes (1), the pipe ends are pressed against the heated welding mirror to heat the thermoplastics material at the end of the pipe ends to a welding temperature to render the plastics material on the joint surface plastic, the welding mirror (5) is removed from between the pipes, the heated pipe ends are pressed against each other so that the thermoplastics materials melt together to form a welded joint, and the welded joint is allowed to cool. The welding mirror (5, 5′) according to the invention is characterized in that the welding mirror is adaptable to the shape of the end surface of the pipe cut along a radial side wall (6) of the hollow profile.

The present invention relates to a method for joining thermoplastics pipes manufactured by spiral winding of a hollow profile with essentially rectangular cross section. The invention relates also to a device for joining pipes made by spiral winding of a hollow profile.

A pipe can be manufactured from a hollow profile by spiral winding of the hollow profile and by fastening, e.g. by welding, each wound round to the nearest preceding wound round. When a pipe made by spiral winding is cut at a right angle to its axis, the end surface of the pipe end is, due to the pitch of the wound profile, provided with a groove-formed recess extending along a major part of the periphery of the pipe and passing into the helically extending channel of the profile. The structure of such pipe ends is irregular and weaker than that of pipes with solid walls, which prevents from joining the pipes together by methods, e.g. by conventional butt welding, used for joining solid walls.

A method widely used for joining together pipes manufactured by spiral winding is to use a sleeve joint. However, a joint made by means of a sealing is not as strong as a welded joint, and the tightness of the joint depends on the rubber sealing being used. Another way to join together spirally wound pipes is to use a thread joint by utilizing the threads of the pipe. The threaded joint as such is not waterproof. This kind of pipes can be joined together also by using a collar on the outer surface of the pipes, especially in connection with threaded joints. However, such a collar is often made from metal, which is not the best alternative for pipes used in outdoor applications. Especially pipes of larger diameter are joined together by extrusion welding. Said welding can be carried out either mechanically with appropriate special equipment, or manually. In extrusion welding, the pipe ends to be joined together are cut along the sidewall of the spirally wound profile, and the end of the profile is cut at a determined angle. Thereafter, the pipes are aligned with each other, abutted against each other and extrusion welded manually or mechanically from the outer surface and/or inner surface of the pipe. However, an externally used welding apparatus falls under special technology. In manually welding, the welding result depends on the person carrying out the welding. Manual welding carried out from the outer surface requires also sufficiently space: for welding the underside of the pipe, the pipe has eventually to be lifted or a hole must be digged under it.

Methods, i.a. an electric welding method, have been developed to eliminate the problems related to the above-mentioned methods. An electric resistance covered with thermoplastics is placed between the trimmed pipe ends, which electric resistance on heating will melt its plastics mantle and the end surfaces of the pipes to be joined. The resistance wire and its plastics cover are left in the joint connecting the pipe ends. A problem related to this method has been i.a. unequal quality of the resulting joint. Because the resistance wire melts only a small amount of the plastics, joining problems will easily appear, if e.g. the end surfaces of the pipes are not even. The pipes must also be carefully aligned to each other and supported by means of an additional root support during the joining process in order to keep the resistance wire or excess molten plastics material between the pipes to be joined.

However, all above-mentioned joining methods are very laborious and time-consuming or a sufficiently strong joint cannot be produced, and some of them will require use of special equipment.

The object of the present invention is to provide a method requiring less pre-preparation and fewer process steps during the welding itself. This is achieved by a method according to claim 1 and an equipment according to claim 8.

By using the method according to the present invention, it is possible partly to utilize existing mirror welding equipments, and a strong and tight pipe joint can be obtained. By using this method, the joining of pipes can be carried out in such a way that the joint is mainly formed of material derived from the pipe ends to be joined. The joining of pipes requires also less precision than the existing joining methods, thus speeding up the joining of pipes on the site.

The invention is described in more detail with reference to the attached drawings wherein

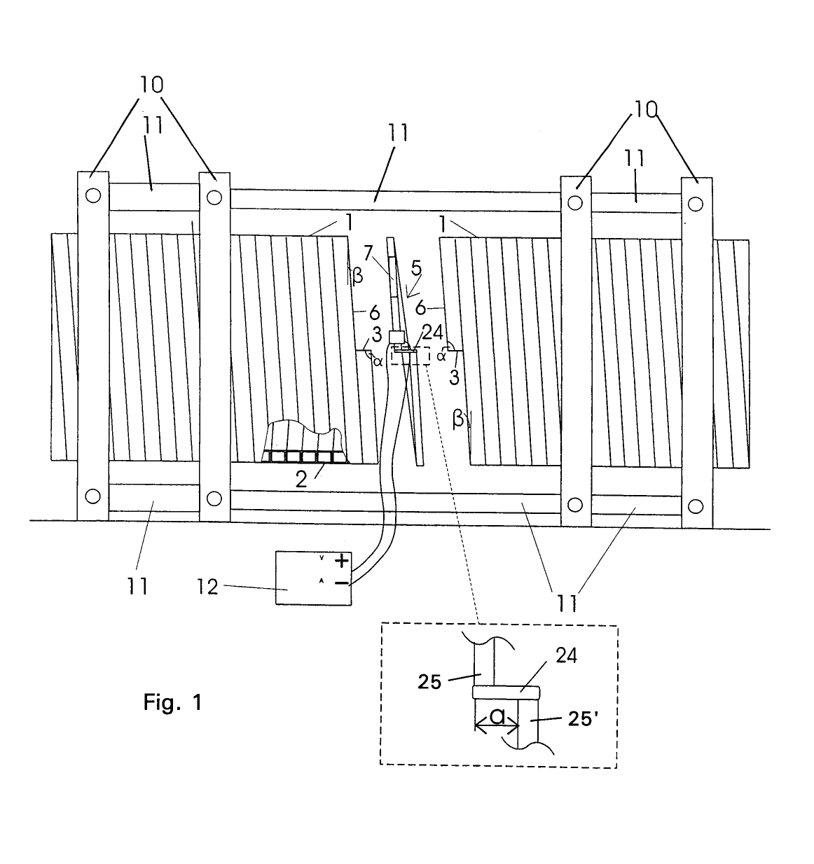

FIG. 1 shows a schematical side view of pipe ends to be joined together and an embodiment of a welding mirror according to the invention,

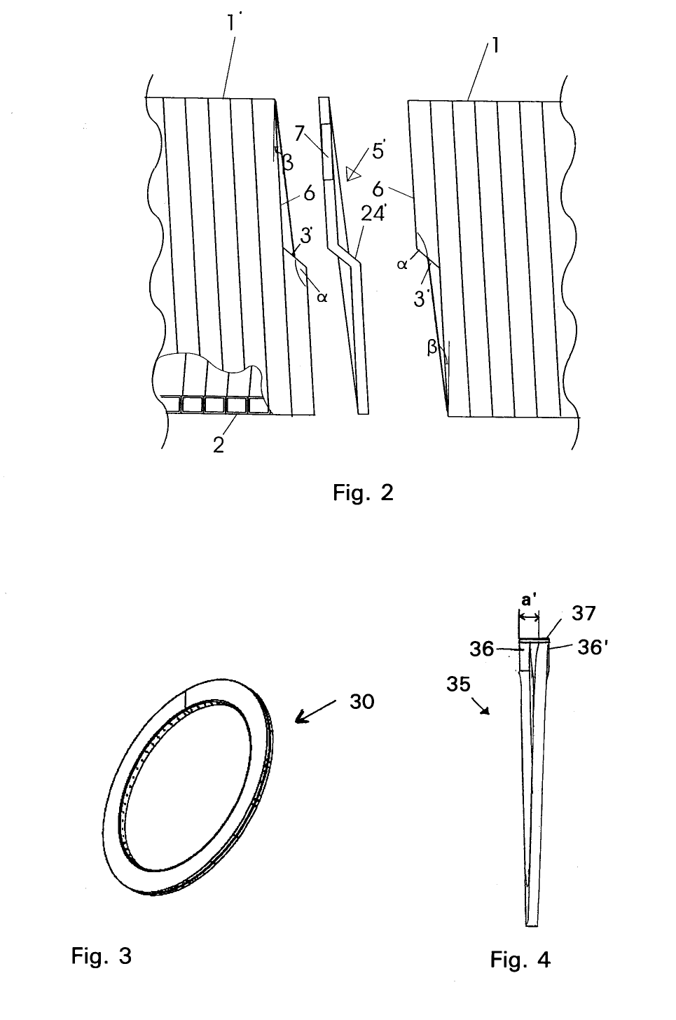

FIG. 2 shows a schematical side view of pipe ends to be joined together and another embodiment of a welding mirror according to the invention,

FIG. 3 shows a schematical view of a welding mirror according to the invention before its adjustment according to the pitch of a pipe end and

FIG. 4 shows a schematical side view of a welding mirror according to the invention after it has been adapted to correspond the pitch of the pipe ends to be joined.

FIG. 1 shows a schematical side view of pipe ends to be joined together, having a welding mirror 5 according to one embodiment of the invention placed between them. The cross section of the pipes is preferably round or essentially round. According to one embodiment of this invention, two thermoplastics pipes 1, made by spiral winding of a hollow profile 2 having mainly rectangular cross section and by welding each wound round to the nearest preceding wound round, are joined together in the following manner:

The pipe ends to be joined together are cut along a radial side wall 6 of the spirally wound profile 2 mainly around the whole periphery of the pipe so that pitch angles (β) of the cut pipe ends (the spiral) are essentially of equal size, and along a line 3 cutting the end of the profile 2. The shape of the section 3 of the end of the profile 2 is essentially compliant to the pipe end to be joined thereto and prepared in the same manner.

Preferably, the pipe ends are cut along an interior surface of the sidewall of the profile 2, which sidewall is fastened to the nearest preceding wound round, resulting in a pipe end with a double wall thickness. The section 3 cuts the end of the profile 2 preferably at a right or an obtuse angle (α), said angle being preferably of equal size or essentially of equal size for both pipe ends.

Preferably, the hollow profile has a mainly rectangular cross section. The hollow profile can also have a cross section with two straight opposite sides, whereas the sides or one of the sides connecting said opposite sides be curved or angular instead of straight. Said opposite, essentially parallel straight sides form then the radial sidewalls of the profile in a pipe made of said hollow profile by spiral winding as described above.

The hole in the cut end of the profile 2 can be closed in connection with the preparation of the pipe end, e.g. by welding a thermoplastics plate onto the hole, by injecting plastics to the hole or by another suitable method, e.g. by plugging, as is described in the Finnish patent application 20031562. Said method is especially suitable for use also after the joining of the pipes.

Thereafter, the two pipes 1 are placed, e.g. into external pipe supports, pipe clamps 10, of a mirror welding equipment or table according to the prior art, coaxially and at a distance from each other. The same pipe clamp can be used for pipes of various sizes (nominal diameter) by using adapters between the pipe clamp and the pipe. The cut profile ends are positioned to essentially abut to each other, in one embodiment to exactly abut to each other, and in another embodiment at a distance from each other, advantageously the distance corresponding the thickness of a connecting part of the welding mirror, after which the pipes are locked in the pipe clamps 10. The pipe clamps 10 are connected to each other by means of a hydraulic cylinder equipment 11 which is arranged to move the pipes axially.

A welding mirror 5 adapted according to the end surfaces of the pipes and provided with heating means, is heated to a welding temperature and inserted in the slot between the end surfaces of the pipes 1. The welding mirror 5 can be connected to a power source 12. The welding mirror is carried e.g. by a support 7 mounted thereto by means of a lifting means. Alternatively, the welding mirror can be supported from underside. The welding mirror is dimensioned to extend at the cut end of the pipe essentially over the whole length of the side surface of the profile and at least over the width of said side surface. In the embodiment shown in FIG. 1, the welding mirror 5 has essentially the same pitch angle (β) as the prepared radial end surfaces 6 of the pipe. Thereafter, the pipe ends are pressed by means of a hydraulic cylinder equipment 11 arranged to press the pipe ends towards the welding mirror 5 inserted between them or towards each other, against the heated welding mirror in order to heat the thermoplastics material on the end surfaces of the pipes 1 to a welding temperature so as to render said material plastic. Alternatively, the welding mirror may have a flexible structure so that the welding mirror is automatically adapted to the pitch angle of the pipe end, when pressed between two pipe ends. After a suitable heating and pressing time, the pressing is stopped, and the welding mirror is removed from its position between the pipe ends. Thereafter, the pipe ends are pressed against each other so that the thermoplastics materials melt together to form a welded joint, after which the welded joint is allowed to cool. The welded joint can also be cooled e.g. by directing an air flow thereto. Finally, the cut profile ends are joined to each other, after which the joint is ready. The profile ends are joined to each other by welding, e.g. by extrusion welding, electric welding or sleeve welding using a method disclosed in the patent application FI 20031562.

When heating the pipe ends of hollow structure pipes cut and prepared as described above to soften them, it is essential that the heating takes place so that the pipe ends are heated so that the structure of the hollow pipe wall softens essentially only at the joint surface. In other case, there is a risk that the structure of the inner and/or outer surface of the pipe, in other words, the side wall(s) of the profile parallel to the pipe axis will collapse during the pressing stage of the heating or the seaming stage. I.a. the diameter of the pipe, the stiffness of the pipe, the wall thickness of the profile and the angle of the cut profile end affect the pressing pressure to be selected. When the present application gives only one value to the diameter of pipe, the inner diameter (mm) of the pipe is meant.

In our studies, it was discovered that a pressing pressure suitable to be used in the method according to our invention for PE-HD-(high density polyethylene) pipe (pipe DN560/500, SN4) for heating and seaming is preferably 0.4 to 1.0 bar, especially 0.5 to 0.8 bar. For the above-mentioned pipe, a time suitable for pressing the pipe ends against the heated welding mirror (heating stage), is approximately 3 to 5 min, and the heated pipe ends are pressed against each other (seaming stage) preferably 20 to 30 min to allow the plastics material at the seam to cool. For larger pipes, especially for a pipe size of DN≧1000, the pressing pressure is during the heating and/or seaming stage preferably at least 1 bar, especially 1.0 to 1.5 bar. For a pipe size of DN 1400, the pressing pressures are preferably in the range of 1.0 to 1.8 bar. The temperature of the heated welding mirror is preferably 210±10° C., especially for PE-HD-plastics. The temperature to be used is selected in accordance with the used plastics (e.g. polypropylene, PE-MD).

The required pressing time and/or pressing pressure can be estimated of the amount of molten plastics forming as a ridge on the heated end surfaces of the pipe. In the method according to the invention, the estimation can be based e.g. on the radial ridge. A ridge must be formed over the whole periphery of the pipe ends. The ridge can remain at its place as such or it can be shaped (smoothed) or cut off.

The welding mirror according to the invention used e.g. in the method according to the invention can be adapted to the form of the end surface of the pipe cut along a radial sidewall of the hollow profile and is provided with heating means (e.g. heating cartridges, resistance elements). Inside the welding mirror, means for its heating are arranged. According to one embodiment, the welding mirror has the form of a cut ring plate. FIG. 2 shows a schematic side view of a part of the thermoplastics pipe ends 1′ to be joined together, and an embodiment of a welding mirror wherein the welding mirror 5′ is adapted to the prepared end surfaces of the pipes, and wherein the ends (25, 25′) of the ring plate are stationarily connected to each other. In another embodiment, the ends of the ring plate are connected to each other so that their axial distance a, i.e. distance in the direction of the pipe axis, is adjustable (FIG. 1). Especially, the distance between the ring plate ends is adjusted to form a pitch angle to the ring essentially corresponding to the pitch 13 of the spiral in the pipe ends to be joined together. Preferably, an element 24 connecting the ends of the cut ring plate is arranged at the inner periphery or especially the outer periphery of the ring plate (FIG. 1). In a further embodiment, the element 24′ connecting the ends of the ring plate is heatable (FIG. 2), being then especially adapted to the cut ends 3′ of the profile 2 and arrangeable between them. Then the joint between the cut ends of the profile can be welded at the same time as the side surface of the profile at the end surfaces of the pipe. The ends of the cut ring plate are connected to each other preferably at an obtuse angle (FIG. 2) and especially at a right angle (FIG. 1) to the ends of the disc.

FIG. 3 shows schematically a view of a welding mirror 30 according to the invention, having a form of a cut ring plate, before its adjustment according to the pitch of a pipe end and FIG. 4 shows schematically a side view of a welding mirror 35 according to the invention when adapted to correspond the pitch of the thread of the pipe ends to be joined and prepared according to the invention. Pitch angle of the heating element 35 is adjusted or set by changing the axial distance a′ between the ring plate ends 36, 36′. The ends of the ring plate are connected with connecting part 37, which here is plate-like and located at the outer periphery of the ring plate.

When the side surfaces of the profile of the pipe ends are heated and seamed at first in the above manner, and thereafter the profile ends separately, it is especially advantageous that no torsional force is required when pressing the heated pipe ends against each other. The section 3 of the ends of the profile 2 has then preferably a shape of 90°.

When the end surfaces of the pipes are heated with a welding mirror simultaneously in their entirety, i.e. including the profile end, and when the profile end 3 is cut with a section cutting the profile 2 at an obtuse angle, a sufficient compressive force is obtained between the cut profile ends by using only a hydraulic cylinder 11, considerably facilitating the joining operation. The bigger the angle α is, the better the welding result will be. Very good results can be obtained if the angle α is 135° or 150°. When, in turn, the heated ends of the profile 2 are cut with a section cutting the profile perpendicularly, in addition to a compressive force pressing the pipe ends together, also a torsional force has to be exerted between the cut profile ends.

1. A method for joining thermoplastics pipes (1) made by spiral winding of a hollow profile (2) with mainly rectangular cross section, whereby the ends of the thermoplastics pipes are prepared so that the pipe receives an step-like end surface by cutting the profile (2) in the end of the pipe along, the radial side wall of the profile so that the pitch angle (β) of the ends of the pipes (the spiral) is essentially the same, and by cutting the end (3) of the profile, the shape of the section (3) being essentially compliant to the pipe end to be joined thereto and prepared in the same manner, after which the pipes (1) to be joined together are placed coaxially and supported on pipe clamps at a distance from each other so that the cut profile ends (3) are essentially aligned with each other, characterized in that a welding mirror (5) adaptable to the prepared end surfaces of the pipes and provided with heating means is inserted in the slot between the pipes (1), the pipe ends are pressed against the heated welding mirror to heat the thermoplastics material at the end of the pipe ends to a welding temperature to render the plastics material on the joint surface plastic, the welding mirror (5) is removed from between the pipes, the heated pipe ends are pressed against each others so that, the thermoplastics materials nick together to form a welded joint and the welded joint is allowed to cool.

2. A method according to claim 1, characterized in that the end (3) of the profile (2) is cut at a right or an obtuse angle (α), said angle being of equal size for both pipes to be joined together.

3. A method according to claim 1, characterized in that the cutting of the profile (2) at the end of the pipe is carried out along the interior surface of its side wall that is fastened to the nearest preceding wound round resulting in and end surface with a double wall thickness.

4. A method according to claim 1, characterized in that the cut profile ends (3) of the pipes (1) are seamed together in a separate working step after the joining of the pipes.

5. A method according to claim 4, characterized in that the profile ends (3) of the pipes (1) are seamed together by welding, preferably by extrusion welding.

6. A method according to claim 1, characterized in that the hole in the cut end (3) of the profile (2) is dosed in connection with the preparing of the pipe end.

7. A method according to claim 6, characterized in that the closing is carried out by welding a plastics plate on the cut profile end (3).

8. A welding mirror (5, 5′) for joining two thermoplastics pipes manufactured by spiral winding of a hollow profile (2), said welding mirror being provided with heating means, characterized in that the welding mirror is adaptable to the shape of the end surface of the pipe cut along a radial side wall (6) of the hollow profile.

9. A welding mirror according to claim 8, characterized in that the welding mirror is shaped as a cut ring plate.

10. A welding mirror according to claim 9, characterized in that it comprises means (24) for adjusting and/or locking the axial distance between the ends of the cut ring plate.

11. A welding mirror according to claim 9, characterized in that it comprises means (24, 24′) fig joining the ends of the cut ring plate together, said means being preferably heatable.

12. A welding mirror (5′) according to claim 8, characterized in that it is adaptable to the shape of the section of the end (3) of the hollow profile (2)

13. A welding mirror according to claim 10, characterized in that it comprises means (24, 24) tier joining the ends of the cut ring plate together, said means being preferably heatable.

14. A welding mirror (5) according to claim 11, characterized in that it is adaptable to the shape of the section of the end (3) of the hollow profile (2).
